(19) United States
(12) Patent Application Publication
(10) Pub. No.: US 2017/0320444 A1
(43) Pub. Date: Nov. 9, 2017

(54) Apparatus for securing portable file box, file tote,storage box, portable food cooler and utility storage containers during transportation or storage by using an application specific adjustable restraint that incorporates the existing shoulder / seat belt safety and/or cargo securing systems in an automobile.

(71) Applicants: PauL Micheal Bober, Glendale, AZ (US); David Micheal Duncan, Glendale, AZ (US)

(72) Inventors: PauL Micheal Bober, Glendale, AZ (US); David Micheal Duncan, Glendale, AZ (US)

(21) Appl. No.: 15/148,582

(22) Filed: May 6, 2016

(51) Int. Cl. B60R 7/04

(52) U.S. Cl. CPC B60R 7/043

(57) ABSTRACT

An apparatus used for securing portable file box, file tote, storage box, food cooler and utility storage containers during transportation or storage by using an adjustable restraint that incorporates the existing shoulder safety belt in an automobile or any other strapping material. The device has molded concave surface with a small ledge extending into the center of the device from the outside edge. The device is designed to accept the perimeter shape of rectangular or square shaped the portable file box, file tote, storage box, food cooler and utility storage containers. The primary elements of the device are the “T” shaped cut-out openings in the frame of the apparatus. The adjusters are adjustable mechanical fastener that prevents random loosening and retains the tension of the length and width setting of the portable file box, file tote, storage box, food cooler and utility storage container. The adjustable mechanical fastener assist with the frictional force against the sides of shaped the portable file box, file tote, storage box, food cooler and utility storage containers. The apparatus has corner holes used to stabilize shaped the portable file box, file tote, storage box, food cooler and utility storage containers while transporting or when the portable file box, file tote, storage box, food cooler and utility storage containers are vertically stack stored. The inside tensioning edge is designed to prevent the restrain form overcoming the top edge of the tote or container while keeping the apparatus in direct contact with the portable file box, file tote, storage box, food cooler and utility storage containers .

The “T” shaped cut-outs can be surface mounted to existing portable file box, file tote, storage box, food cooler and utility storage containers. The “T” shaped cut-outs can be embedded, molded or cast in the sides of portable file box, file tote, storage box, food cooler and utility storage containers and provide the same use as the free standing complete apparatus.

### CROSS REFERENCE TO RELATED APPLICATIONS

### Not Applicable

### STATEMENT REGARDING FEDERALLY SPONSORED RESEARCH OR DEVELOPMENT

### Not Applicable

### DESCRIPTION OF ATTACHED APPENDIX

### Not Applicable

### BACKGROUND OF THE INVENTION

This invention relates generally to the field of transportation and more specifically to an apparatus for securing portable file box, file tote, storage box, portable food cooler and utility storage containers during transportation or storage by using an application adjustable restraint that incorporates the shoulder and set belt safety systems in an automobile or any other strapping material.

While using portable file box, file tote, storage box, food cooler and utility storage containers to keep brochures and samples in your automobile is a fairly common practice, it can be dangerous. There are problems with a portable file box, file tote, storage box, food cooler and utility storage containers not secured or restrained in the seat. Besides the obvious issues with the portable file box, file tote, storage box, food cooler and utility storage containers being upset and unloading itself when you slow; the sudden stop will turn the portable file box, file tote, storage box, food cooler and utility storage containers into a projectile with a huge amount of force behind it. Depending on the location of the portable file box, file tote, storage box, food cooler and utility storage containers prior to the sudden stop, it could merely hit the rear of the set, fall down between the seats or worse—strike the occupants.

After several spills and a couple of fairly heavy blows to the back of the seat, the tote restraint was engineered to secure the portable file box, file tote, storage box, food cooler and utility storage containers to the seat of the automobile or secure portable file box, file tote, storage box, food cooler and utility storage containers in the cargo bed. The tote restraint apparatus keeps the portable file box, file tote, storage box, food cooler and utility storage containers snug against the seat or secured to the side/front/rear of the cargo bed. As the portable file box, file tote, storage box, food cooler and utility storage container is not free to gain momentum, it is easy to control and prevent damages to portable file box, file tote, storage box, food cooler and utility storage containers, the contents held there in as well as the occupants.

While using the shoulder restrain belt just to hold the portable file box, file tote, storage box, food cooler and utility storage containers would work in some instances, the shoulder restraint belt itself interferes with the proper opening and closing of the portable file box, file tote, storage box, food cooler and utility storage containers. There is also no way to keep the shoulder restraint belt snug and in one position on the portable file box, file tote, storage box, food cooler and utility storage containers as most of them have an unusual side shape that prevents keeping tension on the shoulder restraint belt.

When thrown in the cargo bed, the portable file box, file tote, storage box, food cooler and utility storage containers would slide away from the initial starting point as soon as the vehicle moved. Wedging the portable file box, file tote, storage box, food cooler and utility storage containers takes other components and detracts from the portable file box, file tote, storage box, food cooler and utility storage containers usefulness. If the portable file box, file tote, storage box, food cooler and utility storage containers were loose in the cargo bed, they could slide violently into each other and damage the contents as well as create other physical damages. Using rope or straps to secure those works poorly as the smooth plastic does not allow the portable file box, file tote, storage box, food cooler and utility storage containers proper friction against the rope or strap.

The prior technology was to use the seat belt or shoulder safety belt to restrain the portable file box, file tote, storage box, food cooler and utility storage containers. If the portable file box, file tote, storage box, food cooler and utility storage containers were in a cargo bed, it would have to be wedged against the side/front/rear or have rope of something similar wrapped around it.

Deficiencies with the prior technology consisted of some shoulder safety belt/seat belts not having the length and adjustment to accept a tote or container and the shapes of the sides of the portable file box, file tote, storage box, food cooler and utility storage containers does not lend itself to securing. Most portable file box, file tote, storage box, food cooler and utility storage containers are smooth plastic. This is a real problem for a fabric shoulder safety harness/seat belt. If in a cargo bed, wedging it against the side/front/rear did keep the portable file box, file tote, storage box, food cooler and utility storage containers from shifting, but it would be at the expense of the other things that were used to wedge. If rope or a ratchet strap were used, the portable file box, file tote, storage box, food cooler and utility storage containers would distort or break as the smooth plastic sides do not allow for positive securing; damaging the portable file box, file tote, storage box, food cooler and utility storage containers and rendering it useless.

### BRIEF SUMMARY OF THE INVENTION

The primary object of the invention is to provide a light weight portable, adjustable restraint that does not hinder the opening, closing or functions of the portable file box, file tote, storage box, food cooler and utility storage containers, while securing the portable file box, file tote, storage box, food cooler and utility storage containers.

Another object of the invention is the adjustable slides on the device allow for different sized and shaped portable file box, file tote, storage box, food cooler and utility storage containers.

Another object of the invention is the apparatus can be slide up from the bottom of the tote or container and positioned near the top of the tote or container. This will afford maximum efficiency of the apparatus as it is not limited to just one size or shape portable file box, file tote, storage box, food cooler and utility storage containers.

A further object of the invention is the shoulder safety restraint belt of the automobile fit through the slots in the device. The shoulder safety restraint belt prevents the portable file box, file tote, storage box, food cooler and utility storage containers from falling forward/sliding forward/crashing forward or moving side to side.

Yet another object of the invention is the small beveled tensioning ledge on the inside of the device, allowing the apparatus to fit snuggly against any sized or angled rectangular or square shaped portable file box, file tote, storage box, food cooler and utility storage containers.

Still yet another object of the invention is the device will allow portable file box, file tote, storage box, food cooler and utility storage containers to be opened from the top, as it was designed by the manufacture, because the apparatus secures the sides of the portable file box, file tote, storage box, food cooler and utility storage containers.

Another object of the invention are the round port openings in the corners allow for stability for of portable file box, file tote, storage box, food cooler and utility storage containers while being transported on a 2 wheeler or a flat surface configuration, i.e. a hand truck or rolling cart.

Another object of the invention is the round opening in the corners of the device allow for fastening the devices to each other in a daisy chain configuration. The grouping together will prevent portable file box, file tote, storage box, food cooler and utility storage containers from sliding in an S.U.V. cargo area or in a pickup truck bed.

A further object of the invention is the round openings in the corners can be used to secure the portable file box, file tote, storage box, food cooler and utility storage containers to the side/rear/front of a cargo bed.

Another object is the actual “T” shaped slots. The horizontal part of the “T” is positioned on the curved surface to keep the tote restrain positioned to the side of the portable file box, file tote, storage box, food cooler and utility storage containers by using the shoulder restrain or the ratchet strap tensioned.

Yet another object of the invention is the device design can be easily incorporated to existing portable file box, file tote, storage box, portable food cooler and utility storage containers, which eliminate the portable/adjustable functions, allow for a permanent restraint engineered into the toe or container.

Yet another object of the invention is the device is being designed and manufactured in to the sides of portable file box, file tote, storage box, food cooler and utility storage containers allow for the same functions; the device is secured and still able to be used.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus used as a means for securing portable file box, file tote, storage box, portable food cooler and utility storage containers during transportation or storage by using an application adjustable restraint that incorporates the shoulder and/or the seat belt safety systems in an automobile comprising the device has molded or cast curved concave surface with a small ledge extending into the center of the device. The molded part is designed to accept most human fingers and the ledge is a frictional device to work against the side of the portable file box, file tote, storage box, food cooler and utility storage containers. The device is shaped to accept the perimeter shape of rectangular or square shaped portable file box, file tote, storage box, food cooler and utility storage containers.

The primary elements of the device are the “T” shaped openings in the frame of the device with the narrow opening of the slot opening to the outside of the device. The “T” shaped cut out has the top part of the “T” in the main body of the device for strength. The narrow slotted openings allow the easy placement of shoulder safety restraint belt of an automobile or any other strapping material through the device. The shoulder safety belts do not have to be altered in any way and can be snugged down as well; both the long and short sides of the device are adjustable to accommodate any rectangular or square shaped portable file box, file tote, storage box, food cooler and utility storage containers.

The adjuster is a mechanical faster that prevents random loosening and retains the tension of the setting by assisting with the frictional force against the sides of the portable file box, file tote, storage box, food cooler and utility storage containers. The holes in the corners of the device are used to stabilize the portable file box, file tote, storage box, food cooler and utility storage containers while in transportation or when the portable file box, file tote, storage box, food cooler and utility storage containers are vertically stack stored, The holes are designed to accept “Safety Spring Clips”, rope, string, ratchet strap hooks or zip ties. The inside tension edge is designed to allow the shoulder safety belt from an automobile or any strapping material to stand away from the portable file box, file tote, storage box, food cooler and utility storage containers, provide a frictional surface for the device to press against the side of portable file box, file tote, storage box, food cooler and utility storage containers and lastly provide strength and rigidity for the device.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1.

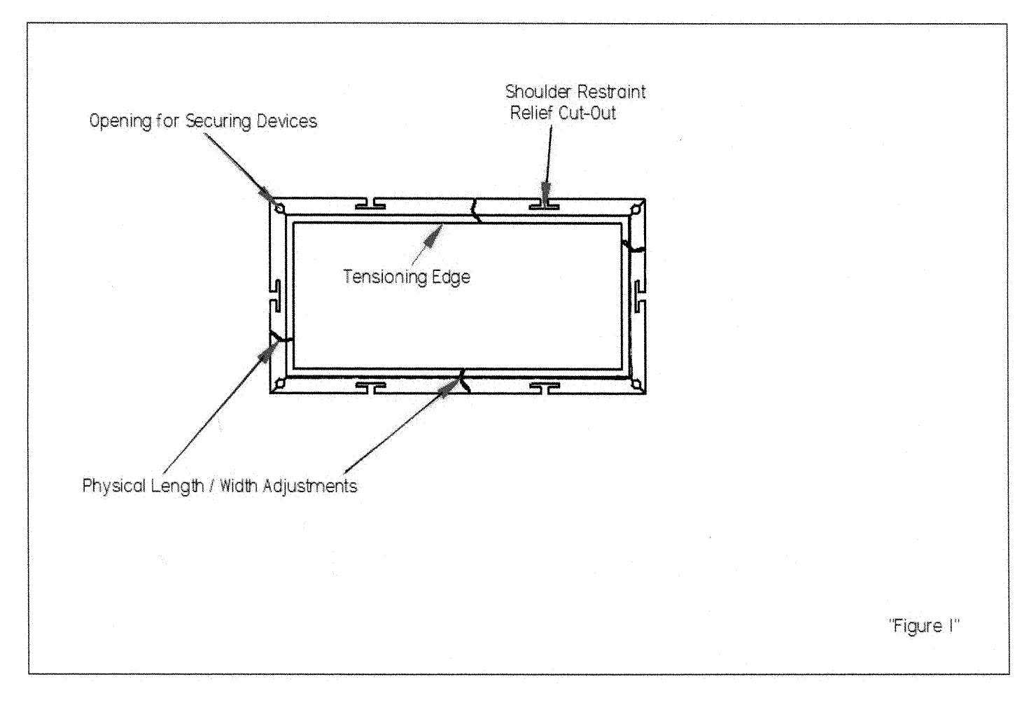

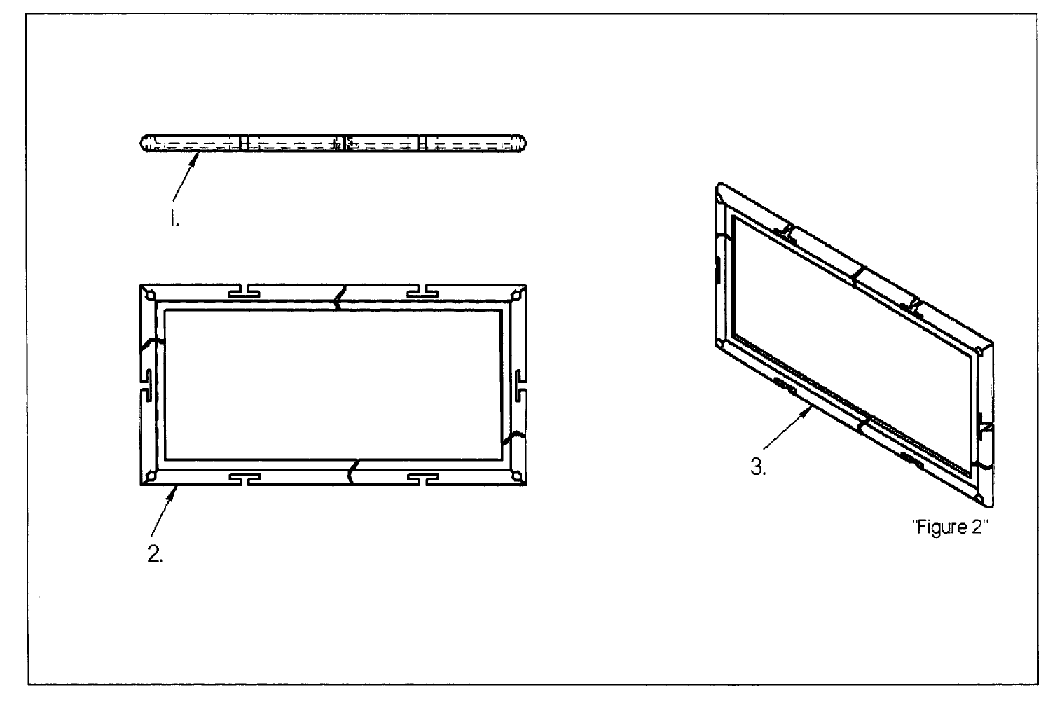

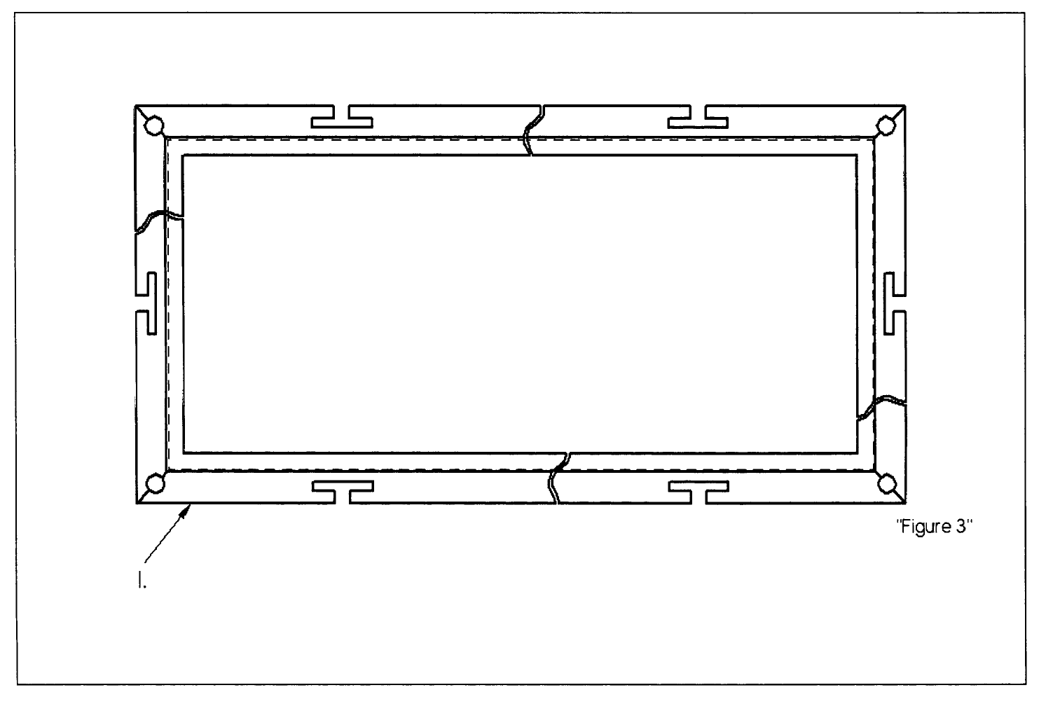

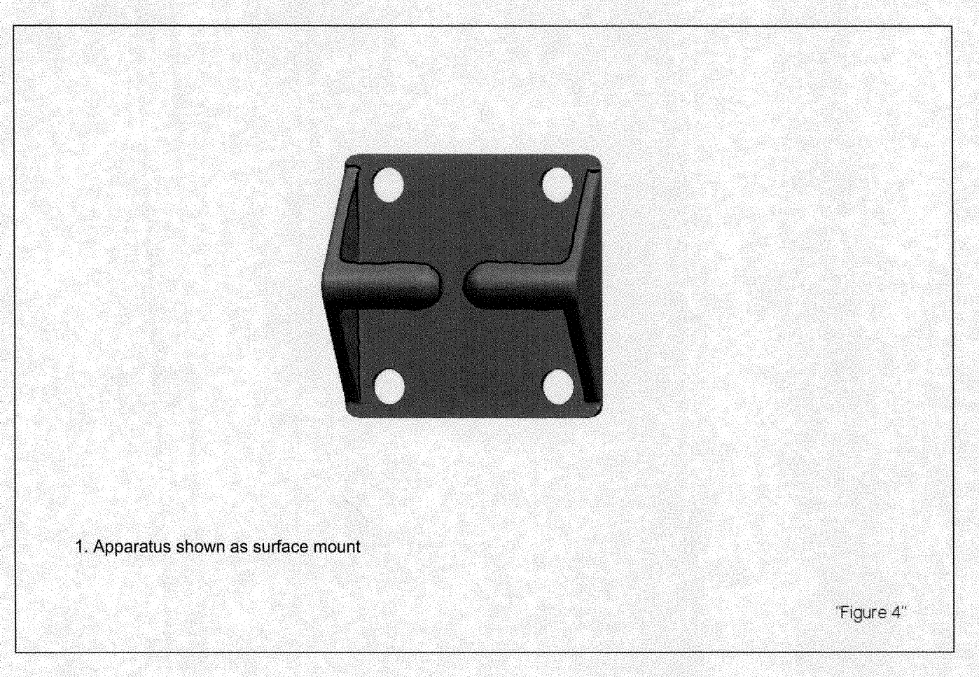

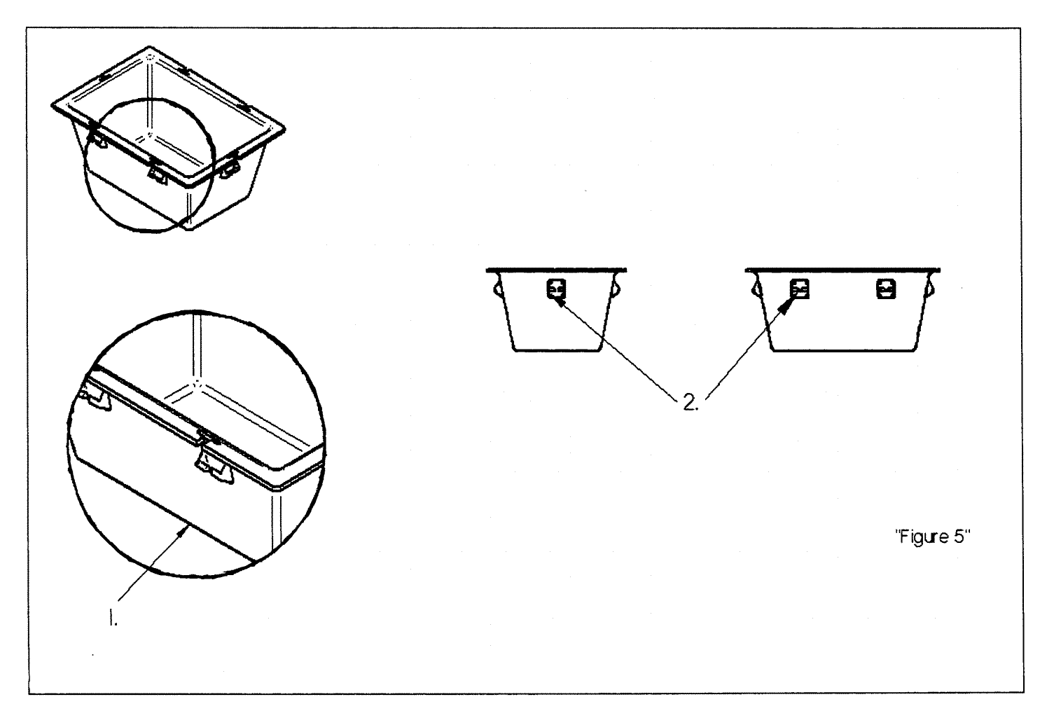

Description: FIG. 1 shows overhead view of apparatus. Visible features are the “Shoulder Restraint Relief Cut-Out”, “Opening for Securing Devices’, “Tensioning Edge”, “Physical Length/Width Adjustments”.

1. Shoulder Restraint Belt Relief Cut-out—the six openings where the shoulder restraint belt is folded and inserted to the “T” shaped opening. Once the shoulder restraint belt is inserted to the “T”. it can be unfolded to the O.E.M. shape.
2. Tensioning Edge—is located on the inside of the apparatus and is designed to keep tension against the portable file box, file tote, storage box, food cooler and utility storage containers .
3. Physical Length and Width Adjusters—the four adjusters allow for correct fitment of the sides of the apparatus to the portable file box, file tote, storage box, food cooler and utility storage containers. The adjusters have a mechanical and friction lock, that once engaged, secures the adjuster to the correct length for the side of the portable file box, file tote, storage box, food cooler and utility storage containers.
4. Opening for Securing Devices—the four corners of each side of the apparatus have a single round opening that will allow for stability for storage or while being transported on a 2 wheeler or a flat surface configuration, i.e. a hand truck or rolling cart portable file box, file tote, storage box, food cooler and utility storage containers. The round opening in the corners of the device allow for fastening the devices to each other in a daisy chain configuration. This will prevent totes or containers from sliding in an S.U.V. cargo area or in a pickup truck bed.

FIG. 2.

Description: FIG. 2 shows the “3-D” View” of the apparatus, Front Sectional View and “Top Down View”.

1. Front Section View—shows the pass through openings and approximate scales for distance and thickness of the apparatus.
2. Top Detail View—shows the dimensions and approximate scales for distance and thickness of the apparatus as well as the Tension Edge width, the relief openings for the six “T” shaped cut-outs and the four round corner openings.
3. The “3-D” View—shows a shaded “3 dimensional” representation of the apparatus when it is fully opened without a portable file box, file tote, storage box, food cooler and utility storage container in the center of the apparatus.

FIG. 3.

Description: FIG. 3 is a “Top View Showing Contour and Friction Edge”.

1. Top View Showing Contour and Friction Edge—the drawing represents the curved outside edge is shaped so the human finger can fit comfortable under the apparatus and the angled inside tension or friction edge keeps the apparatus snug to the sides of the a portable file box, file tote, storage box, food cooler and utility storage container in the center of the apparatus.

FIG. 4.

Description: FIG. 4 drawing shows apparatus as a surface mount. The drawing shows the embodiment as an individual unit.

1. Apparatus shown as surface mount—the drawing that shows face view of the apparatus “T” shaped relief cut-out designed to be flush mounted to a portable file box, file tote, storage box, food cooler and utility storage container. The surface mount apparatus has the important features of the “T” shaped relief cutout; the opening for the shoulder restraint safety belt. As the surface mount is designed to be mounted to the side of a portable file box, file tote, storage box, food cooler and utility storage container, the surface mount has rounded edges on the locating pins. This prevents tearing of the shoulder restraint belt and reduces probability of injury to the end user.

FIG. 5

Description: Embodiment Surface Mounted drawing that shows the relative position of the surface mount embodiment imbedded or molded (by the a portable file box, file tote, storage box, portable food cooler and utility storage container manufacture) into the sides of a portable file box, file tote, storage box, food cooler and utility storage container.

1. Detail A—Embodiment Surface Mounted—the drawing shows a closer view of the surface embodiments mount imbedded or molded (by the a portable file box, file tote, storage box, food cooler and utility storage container manufacture) into the sides of a portable file box, file tote, storage box, food cooler and utility storage container.
2. Position of Embodiment—the drawing shows the relative position of the surface mount embodiments imbedded or molded (by the a portable file box, file tote, storage box, food cooler and utility storage container manufacture) into the sides of a portable file box, file tote, storage box, food cooler and utility storage container.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### Detailed Description of Tote Restraint Device

### Feature 1:

1. As this is a new device, there is nothing old about it. The entire device is new.
2. Feature 1 device is the “T” shaped notches and cut outs that allow for insertion of a strap or stabilizing device.
3. The “T” shaped cutout allows a shoulder restraint belt from an automobile to slide in and secure the device. The relative position of the top horizontal portion of the “T” Shaped cutout is not directly in the center of the curve. It is offset to retain tension of the strap on the device through the use of friction.
4. The shoulder restraint belt is positioned next to the “T” shaped cut out. When the shoulder restraint is slack, it is folded along a lengthwise portion close to the opening of the “T” shaped cutout. The shoulder restraint belt is then inserted, while folded into the vertical portion of the “T” shaped cutout. Once the Shoulder restraint belt is fully inserted in the vertical portion if the “T”, the shoulder restraint belt is allow to expand back to its flat shape. The flat portion now sits in the horizontal partition of the “T” shaped cut out. Once the shoulder restraint belt is properly installed in the “T” shaped cutout, tension the shoulder restraint belt to put tension on the actual tote restraint.
5. The advantages of the “T” shaped cutout are that allows for any width strap or shoulder restraint belt to be used to restraint the actual device.

Feature 2:

1. As this is a new device, there is nothing old about it. The entire device is new.
2. The adjusters on each side of the tote restraint device allow the tote restraint to adjust to any width or length side of any tote or rectangular/square container.
3. The adjusters are a mechanically stabilized device that uses friction to keep the sides of the tote restraint tight agents the tote. Each of the 4 adjusters (one per side) can be adjusted independently of the other sides to allow for offset totes or unusual shaped totes.
4. The tote restraint, once in place near the top of the top of the portable file box, file tote, storage box, food cooler and utility storage containers needs to be adjusted to accept any size or length. By using the adjuster to accommodate for the size on the side it is one, a proper fit can be obtained by decreasing the length of the tote restraint or increasing the length of the tote restraint. The increase/decrease of length are done on each side to provide a snug fit of the tote restraint to the portable file box, file tote, storage box, food cooler and utility storage containers.
5. The advantages of the 4 independent adjusters are that the adjusters function to make each individual side of the tote restraint snug on the portable file box, file tote, storage box, food cooler and utility storage containers.
6. Each of the independent adjustable side has a mechanical locking feature that keeps the length correct for the portable file box, file tote, storage box, food cooler and utility storage containers and retains the correct side length during the use of the tote restraint.

### Feature 3:

1. As this is a new device, there is nothing old about it. The entire device is new.
2. The round port openings that go through the tote restraint are designed to accept normal dimensional pipe to secure containers that are being transported on a pallet truck or similar flat device.
3. The round port opening provides direct access to the tote restraint around a portable file box, file tote, storage box, food cooler and utility storage container that would be stacked directly below the top container with a tote restraint. As the length of plastic pipe is inserted through the round port opening from the top portable file box, file tote, storage box, food cooler and utility storage container's tote restraint to the successive lower tote restraints, the totes become more ridged and less likely to tip over in transit or while in storage in a vertical position.
4. The round port openings can also be used to secure the tote restrain in an open storage bed. Securing or tension devices can be used to secure the tote, which is being held by the tote restraint, through the use of the round access port on each of the four corners of the tote restrain. Portable file box, file tote, storage box, food cooler and utility storage containers can be secured together via the round port opening using plastic cable ties, mechanical spring clips are string/rope.
5. The advantages of the round port opening are that the four openings allow for the use of plastic dimensional pipe to be inserted through the port openings and stabilize a vertical stack of portable file box, file tote, storage box, food cooler and utility storage containers. The round port openings allow for the totes to be stored flat in a larger storage bed and be secured to each other or to the storage bed. The stabilization feature and the horizontal storage features will prevent damage.

### Feature 4:

1. As this is a new device, there is nothing old about it. The entire device is new.
2. The inside tensioning edge of the tote restraint provides the device the ability to secure the tote restraint against the portable file box, file tote, storage box, food cooler and utility storage containers, but still allow for normal access to the portable file box, file tote, storage box, food cooler and utility storage containers from the top opening of the portable file box, file tote, storage box, portable food cooler and utility storage containers.
3. By holding the shoulder restraint belt in the “T” shaped cut out portion of the tote restraint away from the edge/top of the portable file box, file tote, storage box, food cooler and utility storage containers, the shoulder restraint belt does not inhibit the normal opening of the portable file box, file tote, storage box, food cooler and utility storage containers.
4. The tensioning edge also provides a surface for the tote restraint to restrain the actual portable file box, file tote, storage box, food cooler and utility storage containers while retaining the undistorted shape of the portable file box, file tote, storage box, food cooler and utility storage containers.
5. The tensioning edge is slightly beveled to accommodate the different shapes of the sides of portable file box, file tote, storage box, portable food cooler and utility storage containers.
6. The curved portion of the tote restraint allows for normal human fingers to fit under the tote restraint to allow for easier lifting and securing of the portable file box, file tote, storage box, food cooler and utility storage containers.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus used as a means for securing portable file box, file tote, storage box, portable food cooler and utility storage containers during transportation or storage by using an application adjustable restraint that incorporates the shoulder restraint belt in an automobile comprising or any other strapping material;
the device has molded or cast curved concave surface with a small ledge extending into the center of the device, the molded part is designed to accept most human fingers, the ledge is a frictional device to work against the side of the portable file box, file tote, storage box, food cooler and utility storage containers, the device is shaped to accept the perimeter shape of rectangular or square shaped totes or containers;
the primary elements of the device are the T shaped openings in the frame of the apparatus with the narrow vertical opening of the slot open to the outside of the device, the “T” shaped cut-out has the top part of the “T” in the main body of the device for strength, the narrow slotted vertical openings allow the easy placement of shoulder restraint belt of an automobile or any other strapping material through the device, the shoulder restraint belts do not have to be altered in any way and can be snugged down as well;
both the long and short sides of the device are adjustable to accommodate any rectangular or square shaped tote or container, the adjuster is a mechanical faster that prevents random loosening and retains the tension of the setting and assist the frictional force against the sides of the tote or container.

2. The apparatus of claim 1, further comprising of holes in the corners of the device are used to stabilize the tote or container while in transportation or when the portable file box, file tote, storage box, food cooler and utility storage containers are vertically stack stored; the holes are designed to accept “Safety Spring Clips”, rope, string, ratchet strap hooks or zip ties.

3. The apparatus of claim 1, further is designed to allow the shoulder safety belt from an automobile to stand away from the tote or container while the inside frictional edge provides a frictional surface for the device to press against the side of tote or container and lastly provide strength and rigidity for the device.

4. The apparatus of claim 1, further is designed to have the “T” shaped cut-out either surface mounted as an independent apparatus and an add-on to existing the portable file box, file tote, storage box, portable food cooler and utility storage containers or embedded in the design of the portable file box, file tote, storage box, food cooler and utility storage containers by the manufacture.
